(19) United States
(12) Patent Application Publication
(10) Pub. No.: US 2012/0206348 A1
(43) Pub. Date: Aug. 16, 2012

(54) DISPLAY DEVICE AND METHOD OF CONTROLLING THE SAME

(76) Inventors: Sangki KIM, Seoul (KR); Kyungyoung Lim, Seoul (KR); Soungmin Im, Seoul (KR)

(21) Appl. No.: 13/024,691

(22) Filed: Feb. 10, 2011

(51) Int. Cl. G06F 3/033

(52) U.S. Cl. 345/158

(57) ABSTRACT

A display device and a method of controlling the same are provided. The display device comprises: a camera for acquiring an image comprising a gesture taken by a user; and a controller for extracting the gesture from the image acquired by the camera and for setting a specific point of an object in which the gesture is performed as a reference point when the gesture corresponding to acquisition of a control right is comprised in the extracted gesture. Therefore, by setting a specific point of an object in which the gesture corresponding to acquisition of a control right is performed as a reference point, a gesture taken by a user can be accurately and effectively recognized.

### BACKGROUND

1. Field

This document relates to a display device and a method of controlling the same, and more particularly, to a display device and a method of controlling the same that can accurately and effectively recognize a gesture taken by a user by setting a specific point of an object in which a gesture corresponding to acquisition of a control right is performed as a reference point.

2. Related Art

As a terminal such as a personal computer, a laptop computer, and a mobile phone has various functions, the terminal is embodied as a multimedia player having complex functions such as photographing of a still picture or a moving picture, reproduction of music or a moving picture file, game playing, and reception of broadcasting.

A terminal as a multimedia device generally has a function of displaying various image information, the terminal may be called a display device.

The display device is classified into a portable type and a fixed type according to mobility. The portable type display device may comprise, for example, a laptop computer and a mobile phone, and the fixed type display device may comprise, for example, a television and a monitor for a desktop computer.

### SUMMARY

An aspect of this document is to provide a display device and a method of controlling the same that can accurately and effectively recognize a gesture taken by a user by setting a specific point of an object in which a gesture corresponding to acquisition of a control right is performed as a reference point.

In an aspect, a display device comprises: a camera for acquiring an image comprising a gesture taken by a user; and a controller for extracting the gesture from the image acquired by the camera and for setting a specific point of an object in which the gesture is performed as a reference point when a gesture corresponding to acquisition of a control right is comprised in the extracted gesture.

In another aspect, a display device comprises: a camera for acquiring an image of a user who acquires a control right; and a controller for tracking a reference point comprised in the image and for executing a function corresponding to a gesture trajectory formed by movement of the reference point after acquiring the control right.

In another aspect, a method of controlling a display device, the method comprises: acquiring an image; extracting a user' gesture from the acquired image; and setting, when a gesture corresponding to acquisition of a control right is comprised in the extracted gesture, a specific point of an object in which the gesture is performed as a reference point.

In a display device and a method of controlling the same according to this document, by setting a specific point of an object in which a gesture corresponding to acquisition of a control right is performed as a reference point, a gesture taken by a user can be accurately and effectively recognized.

### BRIEF DESCRIPTION OF THE DRAWINGS

The implementation of this document will be described in detail with reference to the following drawings in which like numerals refer to like elements.

FIG. 1 is a block diagram illustrating a configuration of a display device according to an implementation of this document;

FIGS. 2 to 4 are flowcharts illustrating operation of the display device of FIG. 1;

FIG. 5 is a diagram illustrating a process in which the display device of FIG. 1 acquires a user's gesture;

FIG. 6 is a diagram illustrating a time point in which a specific user acquires a control right of the display device of FIG. 1;

FIGS. 7 and 8 are diagrams illustrating a gesture acquiring a control right of the display device of FIG. 1;

FIG. 9 is a diagram illustrating a process of tracking a gesture action of a user who acquires a control right of the display device of FIG. 1;

FIGS. 10 and 11 are diagrams illustrating a gesture action tracking process of the display device of FIG. 1; and

FIGS. 12 and 13 are diagrams illustrating a gesture action tracking process according to a distance of the display device of FIG. 1.

### DETAILED DESCRIPTION

These and other advantages of this document will become more readily apparent with reference to the accompanying drawings, in which implementations of the invention are shown. Hereinafter, an implementation of this document will be described in detail with reference to the attached drawings. Like reference numerals designate like elements throughout the specification. Further, detailed descriptions of well-known functions and structures incorporated herein may be omitted to avoid obscuring the subject matter of this document.

Hereinafter, a display device according to this document will be described in detail with reference to the accompanying drawings. In the following description, suffixes “module” and “unit” are given to components of a display device in consideration of only facilitation of a description and do not have meanings or functions discriminated from each other.

The display device described in this specification comprises a mobile phone, a smart phone, a laptop computer, a digital broadcasting terminal, personal digital assistants (PDA), a portable multimedia player (PMP), a navigation device, a television and so on.

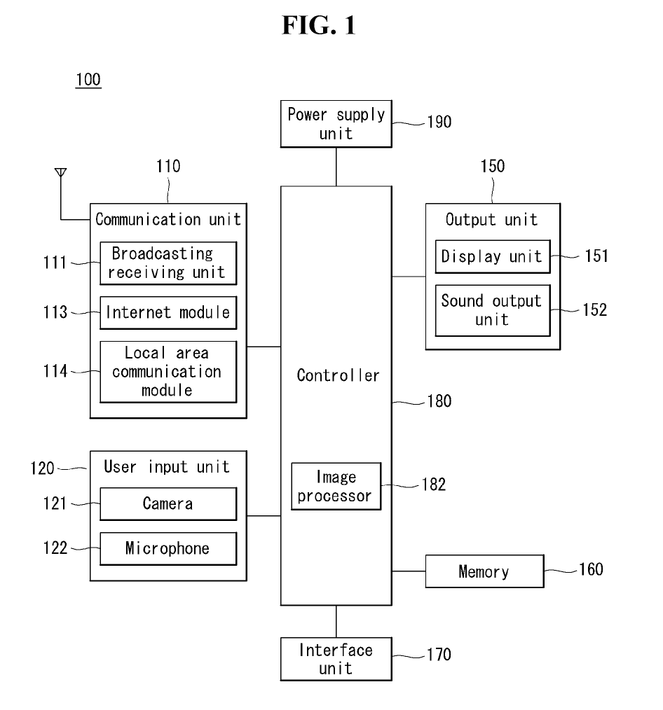

FIG. 1 is a block diagram illustrating a configuration of a display device according to an implementation of this document.

Referring to FIG. 1, a display device 100 according to an implementation of this document comprises a communication unit 110, a user input unit 120, an output unit 150, a memory 160, an interface unit 170, a controller 180, and a power supply unit 190. Components shown in FIG. 1 are components that can be normally comprised in the display device. Therefore, a display device comprising components more or less than the above-described components can be embodied.

The communication unit 110 comprises at least one module for enabling to perform communication between the display device 100 and a communication system or between the display device 100 and other device. For example, the communication unit 110 comprises a broadcasting receiving unit 111, an Internet module 113, and a local area communication module 114.

The broadcasting receiving unit 111 receives a broadcasting signal and/or broadcasting related information from an external broadcasting management server through a broadcasting channel.

The broadcasting channel comprises a satellite channel and a terrestrial channel. The broadcasting management server is a server for generating and transmitting a broadcasting signal and/or broadcasting related information, or a server for receiving a previously generated broadcasting signal and/or broadcasting related information to transmit the previously generated broadcasting signal and/or broadcasting related information to a terminal. The broadcasting signal comprises a television broadcasting signal, a radio broadcasting signal, a data broadcasting signal, and a broadcasting signal in which a data broadcasting signal is coupled to a television station signal or a radio broadcasting signal.

The broadcasting related information is information related to a broadcasting channel, a broadcasting program, or a broadcasting service provider. The broadcasting related information can be provided through a communication network.

The broadcasting related information may exist in various forms, for example, a form of an electronic program guide (EPG) of digital multimedia broadcasting (DMB), or an electronic service guide (ESG) of digital video broadcast-handheld (DVB-H).

The broadcasting receiving unit 111 receives a broadcasting signal using various broadcasting systems. A broadcasting signal and/or broadcasting related information received through the broadcasting receiving unit 111 is stored in the memory 160.

The Internet module 113 is a module for Internet connection. The Internet module 113 is installed at the inside or the outside of the display device 100.

The local area communication module 114 is a module for local area communication. Local area communication technology can use Bluetooth, radio frequency identification (RFID), infrared data association (IrDA), ultra wideband (UWB), ZigBee, etc.

The user input unit 120 is used for inputting an audio signal or a video signal and comprises a camera 121 and a microphone 122.

The camera 121 processes an image frame of a still picture or a moving picture obtained by an image sensor in an audiovisual communication mode or a photographing mode. The processed image frame is displayed in the display unit 151. The camera 121 can perform two-dimensional or three-dimensional photographing and can be formed as a two-dimensional camera, a three-dimensional camera, or a combination of a two-dimensional camera and a three-dimensional camera.

An image frame processed in the camera 121 is stored in the memory 160 or is transmitted to the outside through the communication unit 110. At least two cameras 121 may be installed according to a configuration of the display device 100.

The microphone 122 receives an external sound signal to process the external sound signal into electrical data in a communication mode, a recording mode, or a voice recognition mode. The microphone 122 uses various noise removal algorithms for removing noise generating in a process of receiving an external sound signal.

The output unit 150 comprises a display unit 151 and a sound output unit 152.

The display unit 151 displays information processed in the display device 100. For example, the display unit 151 displays a user interface (UI) or a graphic user interface (GUI) related to the display device 100. The display unit 151 may be at least one of a liquid crystal display (LCD), a thin film transistor-LCD, an organic light-emitting diode, a flexible display, and a three-dimensional display. Further, the display unit 151 may be formed in a transparent type or a light transmitting type. In this case, the display unit 151 is referred to as a transparent display, and a typical transparent display is a transparent LCD. A rear structure of the display unit 151 may be also formed in a light transmitting structure. By such a structure, a user can view an object positioned at the rear of a terminal body through an occupying area of the display unit 151.

At least two display units 151 may exist according to an implementation form of the display device 100. For example, in the display device 100, a plurality of display units 151 may be disposed separately or integrally in a single surface and may be each disposed in different surfaces.

When the display unit 151 and a sensor for detecting a touch action (hereinafter, referred to as a ‘touch sensor’) form an interlayer structure (hereinafter, referred to as a ‘touch screen’), the display unit 151 can be used as an input device in addition to an output device. The touch sensor can have a form of, for example, a touch film, a touch sheet, and a touch pad.

The touch sensor converts a change of a pressure applied to a specific portion of the display unit 151 or a capacitance generating in a specific portion of the display unit 151 to an electrical input signal. The touch sensor can detect a pressure upon touching as well as a touched position and area.

When a touch is input to the touch sensor, a signal corresponding to the touch input is sent to a touch controller. The touch controller processes the signal and transmits data corresponding thereto to the controller 180. Thereby, the controller 180 can know a touch area of the display unit 151.

The sound output unit 152 may output audio data received from the communication unit 110 or stored in the memory 160. The sound output unit 152 outputs a sound signal related to a function (e.g., call signal reception sound and message reception sound) performed in the display device 100. The sound output unit 152 comprises a receiver, a speaker, and a buzzer.

The memory 160 stores a program for operating the controller 180 and temporarily stores input/output data (e.g., a phonebook, a message, a still picture, and a moving picture). The memory 160 stores data about a vibration and sound of various patterns that are output when a touch is input on a touch screen.

The memory 160 comprises at least one storage medium of a flash memory type, a hard disk type, a multimedia card micro type, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The display device 100 may operate to be related to a web storage for performing a storage function of the memory 160 in Internet.

The interface unit 170 functions as a passage of all external devices connected to the display device 100. The interface unit 170 receives data or power from an external device to transfer data or power to each component within the display device 100 or to transmit data within the display device 100 to the external device. For example, the interface unit 170 may comprise a wired/wireless headset port, an outer charger port, a wired/wireless data port, a memory card port, a port for connecting a device having an identification module, an audio input/output (I/O) port, a video input/output (I/O) port, and an earphone port.

The controller 180 controls general operations of the display device. For example, the controller 180 performs a control and processing related to audio dedicated communication, data communication, and audiovisual communication. The controller 180 comprises an image processor 182 for an image processing. The image processor 182 will be described in detail in a related part.

The power supply unit 190 receives an external power source and an internal power source to supply power necessary for operating components by the control of the controller 180.

Various implementations described here are embodied with a record medium that can read with a computer or a device similar to the computer using, for example, software, hardware, or a combination thereof. According to a hardware method, an implementation described here is embodied using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electric units for performing a function. In some case, such implementations can be embodied by the controller 180.

According to a software method, implementations such as a procedure or a function can be embodied with a separate software module for allowing to perform at least one function or operation. A software code can be embodied by a software application written with an appropriate programming language. Further, the software code is stored in the memory 160 and is executed by the controller 180.

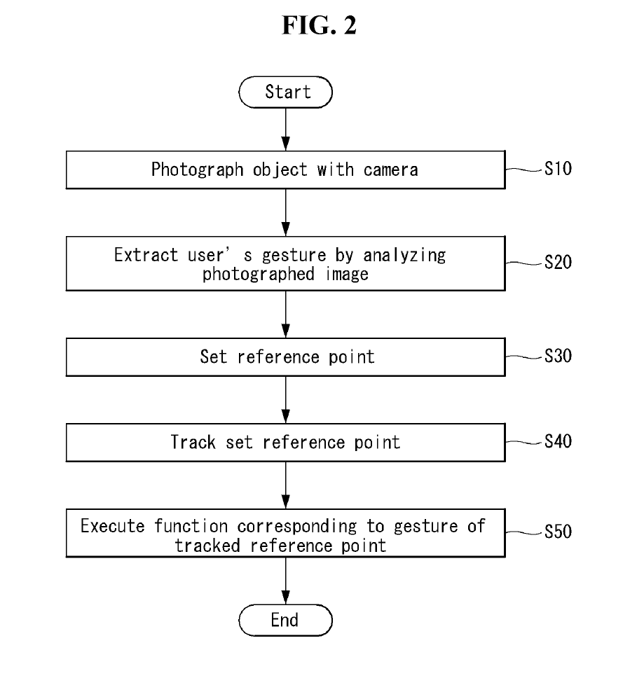

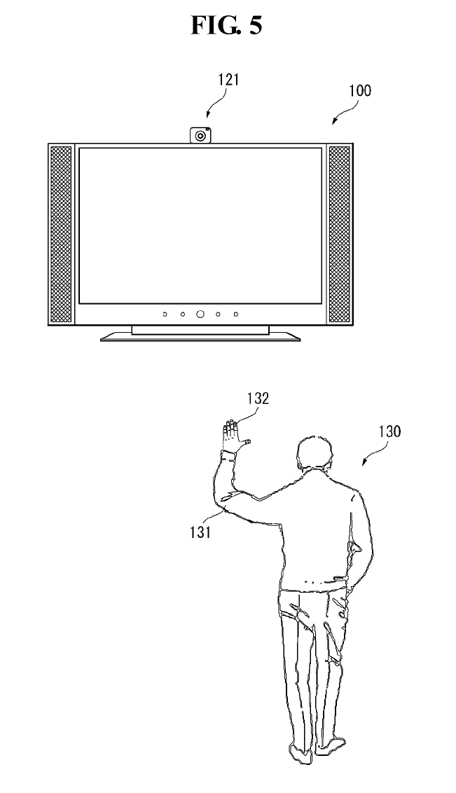

FIGS. 2 to 4 are flowcharts illustrating operation of the display device of FIG. 1, and FIG. 5 is a diagram illustrating a process in which the display device of FIG. 1 acquires a user's gesture.

Referring to FIGS. 2 to 5, the controller 180 of FIG. 1 of the display device 100 according to an implementation of this document controls the camera 121 of FIG. 1 to photograph an object (S10).

The object is a user 130 comprised in an image photographed through the camera 121 of the display device 100. The camera 121 photographs the front of the display device 100. Therefore, the camera 121 photographs various objects such as the user 130 existing at the front of the display device 100. That is, the object may be various objects comprised in an image photographed through the camera 121.

The controller 180 extracts a gesture of the user 130 by analyzing the photographed image (S20).

An object photographed through the camera 121 may comprise the user 130. The photographed object may comprise the user 130 of the display device 100. That is, the user 130 existing at the front of the display device 100 can be photographed by the camera 121.

The photographed image may comprise a gesture of the user 130. That is, a specific action in which the user 130 performs toward the camera 121 can be photographed. The controller 180 extracts a specific operation, i.e., a gesture performed by the user 130 from an image comprising various objects.

A gesture and a posture are classified and used. That is, the gesture is a set of postures taken at a specific moment. However, in a description of this document, a term ‘gesture’ comprises a posture.

The gesture of the user 130 may be a specific action in which the user 130 takes by moving an arm 131, or a specific pose in which the user 130 takes by moving a hand 132. The controller 180 can extract only a gesture taken by the user 130 other than other portions from the photographed image. The gesture of the user 130 can be extracted by recognizing a person's shape from the photographed image. For example, when a shape of a head, a trunk, an arm, and a leg of a person exists in the photographed image, it is recognized as a person. Further, a portion that extends from a trunk and that moves from a position adjacent to a head is an arm, and the user's image is extracted using a method of recognizing an end portion of the arm as a hand. The controller 180 recognizes an image in which a hand portion moves in the extracted image as a gesture of the user 130.

When the user' gesture is extracted, the controller 180 sets a reference point based on the extracted gesture (S30), and the controller 180 tracks the set reference point (S40).

The reference point is a tracking target of the controller 180 for recognizing a gesture. The reference point may be a specific point or a predetermined area. For example, the reference point may be an entire area of the hand 132 of the user 130 or a point of the center of the hand 132.

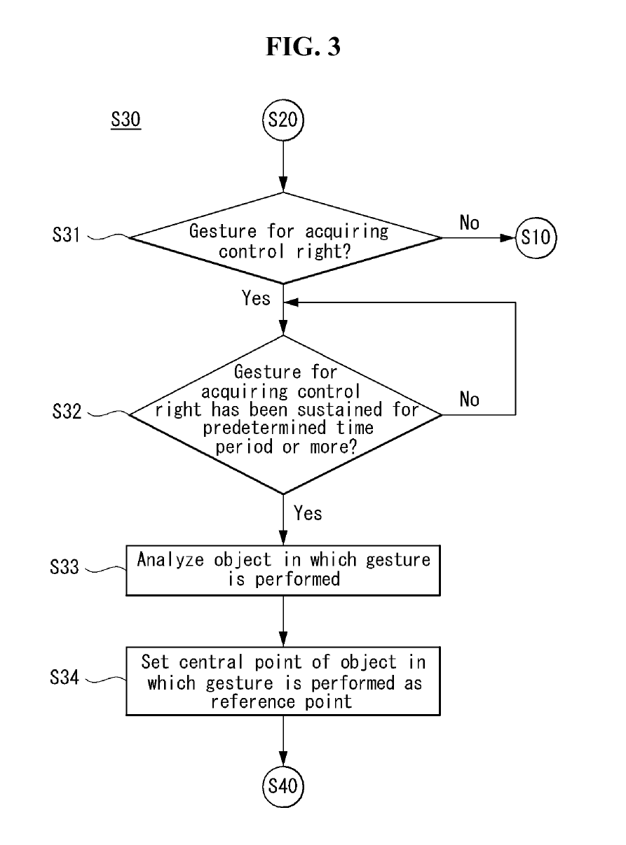

Hereinafter, step S30 of setting a reference point will be described in detail with reference to FIG. 3.

Step S30 of setting a reference point comprises step S31 of determining whether the extracted gesture is a gesture for acquiring a control right.

In order for the user 130 to control the display device 100 based on a gesture action, a process of acquiring a control right of the display device 100 is necessary. When the user 130 takes a specific gesture action, the control right of the display device 100 is acquired. The controller 180 determines whether a specific gesture action is a gesture for acquiring a control right (S31).

A specific gesture for acquiring a control right is preset. The specific gesture is set when producing the display device 100, or is set as a gesture for acquiring a control right by a user of the display device 100. For example, a user' preferable action such as opening a fist or closing a fist toward the camera 121 of the display device 100 may be set as a gesture for acquiring a control right.

If a specific gesture action is a gesture for acquiring a control right, the controller 180 determines whether a gesture for acquiring a control right has been sustained for a predetermined time period or more (S32).

If a gesture for acquiring a control right has been sustained for a predetermined time period or more, the user 130 controls the display device 100, as describe above. That is, this means that a control right for executing a specific function of the display device 100 is given to a specific user 130. However, the user 130 may accidentally take an action corresponding to a gesture for acquiring a control right. That is, although the user 130 does not have an intention to control the display device 100, the user 130 may acquire a control right by an accidental action. When a control right of the display device 100 is acquired by an accidental action of the user 130, it is difficult to effectively control the display device 100. Therefore, the controller 180 of the display device 100 according to an implementation of this document determines whether a gesture for acquiring a control right is input and has been sustained for a predetermined time period or more.

If a gesture for acquiring a control right has been sustained for a predetermined time period or more at step S32, the controller 180 analyzes an object in which the gesture is performed (S33) and sets a central point of an object in which the gesture is performed as a reference point (S34).

The object in which the gesture is performed may be the hand 132 of the user 130. For example, when the user 130 performs a gesture action of opening a fist in a direction of the camera 121 in order to acquire a control right, the controller 180 determines that a gesture for acquiring a control right is performed.

If a gesture for acquiring a control right has been sustained for a predetermined time period or more, the controller 180 analyzes a palm, which is an object in which the gesture is taken. For example, the controller 180 may analyze an area of a palm.

After analyzing an object in which the gesture is taken, the controller 180 sets a central point of the object in which a gesture is performed as a reference point. As described above, a reference point may be a predetermined area or a specific point. Hereinafter, for convenience of description, a case of setting a reference point as a specific point will be described.

The controller 180 sets a central point of an object as a reference point. By analyzing the object in which a gesture is performed, the controller 180 sets a central point of an object as a reference point.

When a reference point is set, the controller 180 tracks the set reference point at step S40.

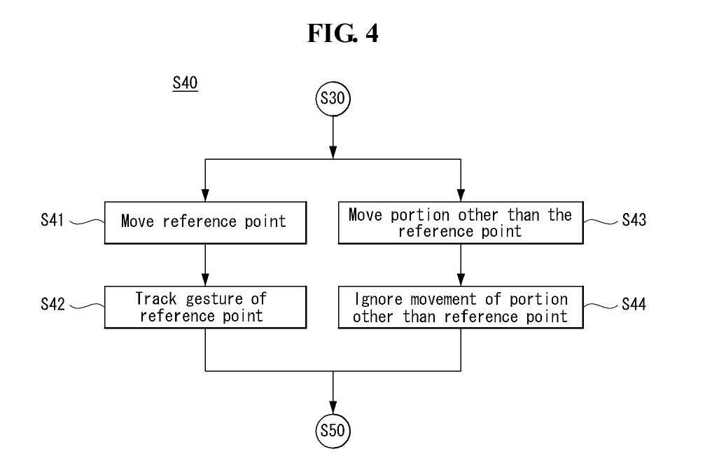

Hereinafter, step S30 of tracking a reference point will be described in detail with reference to FIG. 4.

After a reference point is set, when the reference point is moved (S41), the controller 180 tracks a gesture of the reference point (S42). However, when a portion other than the reference point is moved (S43), the controller 180 ignores movement of the portion other than the reference point (S44).

As a specific reference point is set, after a specific reference point is set, until a specific event of losing a control right occurs, the controller 180 grasps an intention of the user 130 by tracking the reference point. For example, the camera 121 may photograph only a specific point of a palm, which is a reference point, or the controller 180 may analyze an image of only a reference point. Therefore, limited resources of the display device 100 can be more effectively used.

After the set reference point is tracked, the controller 180 executes a function corresponding to a gesture of the tracked reference point (S50).

The user 130 who acquires a control right controls the display device 100 to perform a specific function through a gesture action. For example, the user 130 can change a broadcasting channel through a gesture action of a vertical direction, or can adjust a volume through a gesture action of drawing a circle. By tracking a reference point, when a gesture corresponding to a specific function is input, the controller 180 executes a specific function.

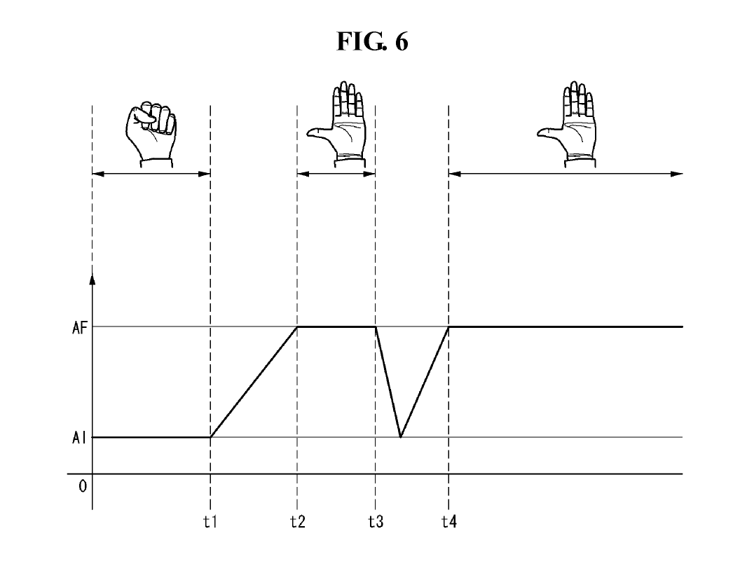

FIG. 6 is a diagram illustrating a time point in which a specific user acquires a control right of the display device of FIG. 1.

Referring to FIG. 6, the controller 180 of the display device 100 according to an implementation of this document determines whether a specific user 130 acquires a control right based on a time period in which a specific gesture has been sustained.

A vertical axis of a shown graph is an occupying area of a photographed object. When the photographed object is a hand, a first area AI indicates a case where an area of the photographed hand is a minimum, and a second area AF indicates a case where an area of the photographed hand is a maximum. When an area of the photographed hand is a minimum, the user 130 is in a state of closing a fist. Further, when an area of the photographed hand is a maximum, the user 130 is in a state of opening a fist.

An area of a hand photographed through the camera 121 can be sequentially changed. For example, the user 130 may close a fist up to a time point t1. The user 130 may open a fist between t1 and t2 and allow an entire palm to photograph between t2 and t3. The user 130 may close a fist and open again a fist between t3 and t4 and sustain an opening state of a fist since t4.

Firstly, the controller 180 determines whether the user 130 performs a gesture action for acquiring a control right. Secondly, the controller 180 determines whether a gesture action for acquiring a control right has been sustained for a predetermined time period or more.

A gesture action for acquiring a control right may be, for example, an action in which the user 130 opens a fist. Therefore, a gesture action between 0 and t1 is not a gesture action for acquiring a control right.

The user 130 performs a gesture action of opening a fist between t2 and t3 and since t4. Therefore, the controller 180 determines that a gesture action for acquiring a control right is performed. However, a time period between t2 and t3 may be short as a gesture action for acquiring a control right. Therefore, the controller 180 may determine that a gesture action between t2 and t3 is not a gesture action for acquiring a control right. A gesture action since t4 is an action for acquiring a control right, and a gesture has been sustained for a predetermined time period or more. Therefore, the controller 180 allows the user 130 to acquire a control right of the display device 100 based on a gesture action since t4.

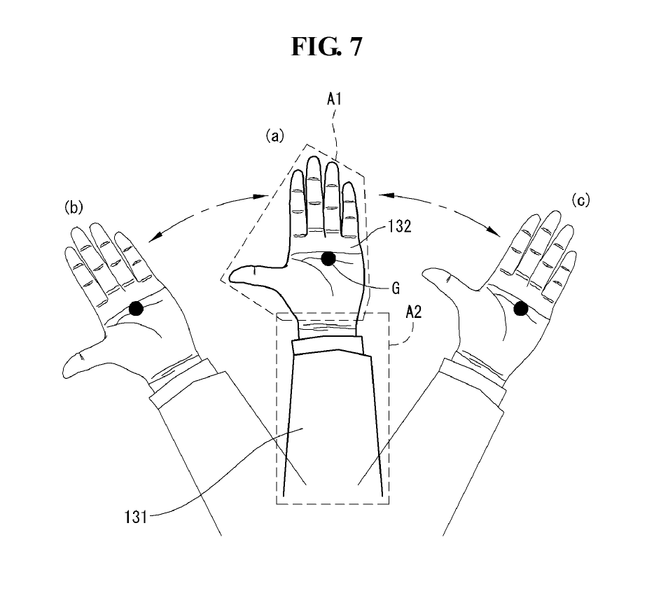

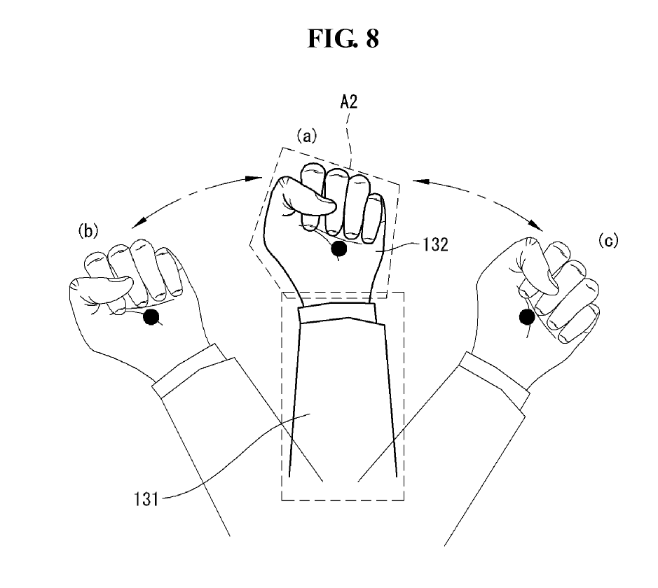

FIGS. 7 and 8 are diagrams illustrating a gesture acquiring a control right of the display device of FIG. 1.

Referring to FIGS. 7 and 8, the controller 180 of the display device 100 according to an implementation of this document determines whether a specific gesture action taken by the user 130 is an action for acquiring a control right, and if a specific gesture action taken by the user 130 is an action for acquiring a control right, the controller 180 sets a reference point G.

As shown in FIG. 7, a gesture action for acquiring a control right may be an action in which a user opens a fist.

When the user takes an action of opening the hand 132, the user can take a gesture in various angles, such as gesture actions a, b, and c. Furthermore, the user may take a gesture of shaking the hand 132 in a direction b or c. The controller 180 determines that a gesture action as a gesture action for acquiring a control right is performed only when a gesture action is performed in a specific direction of directions a to c and that a gesture action for acquiring a control right is performed when the hand 132 opens even in any case.

When the user 130 sustains a gesture action (a) of opening the hand 132 for a predetermined time period or more, the controller 180 allows the user to acquire a control right. Further, the controller 180 determines a central point of the hand 132 by analyzing the hand 132, which is the photographed object and sets the central point as a reference point G.

When a reference point G is set, the controller 180 tracks movement of the reference point G. That is, the controller 180 can continuously track that the user 130 takes any gesture action of a to c. When a gesture of the user 130 corresponds to a specific function, the controller 180 tracking a gesture action about the reference point G executes a corresponding function.

As shown in FIG. 8, a gesture action of acquiring a control right may be an action in which the user 130 closes a fist. That is, when the user 130 closes a fist for predetermined time or more, the controller 180 controls a user who takes a gesture of closing a fist to acquire a control right.

When the user acquires a control right with a gesture action of closing a fist, the controller 180 can track the user's gesture action about the reference point G, which is a central point of a fist. By setting a reference point G and tracking a gesture about the reference point G, it is unnecessary to track other objects. Therefore, resources of the display device 100 can be more effectively used.

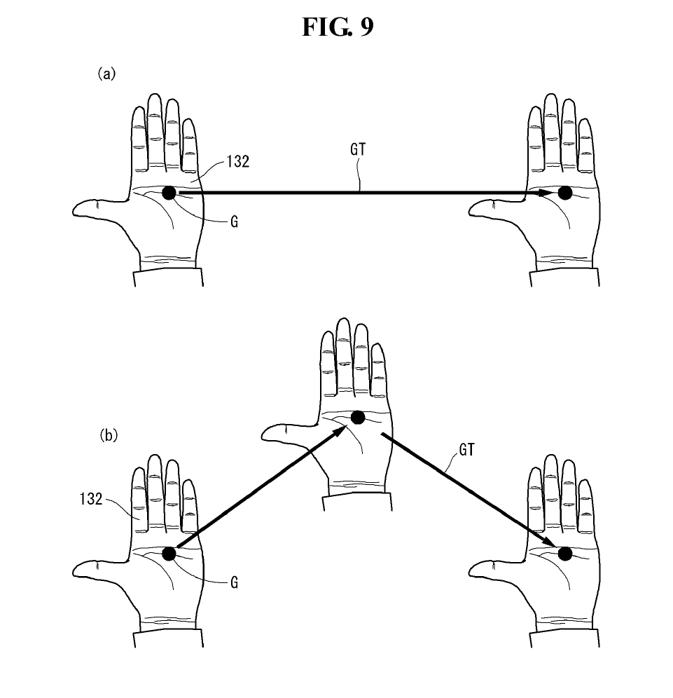

FIG. 9 is a diagram illustrating a process of tracking a gesture action of a user who acquires a control right of the display device of FIG. 1.

Referring to FIG. 9, when the user moves the hand 132, the controller 180 determines a gesture taken by the user by tracking movement of a reference point G.

As shown in FIG. 9(a), the user moves the hand 132 in a horizontal direction. The controller 180 tracks a reference point G in an image photographed by the camera 121. When the controller 180 tracks the reference point G, a reference trajectory GT, which is a trajectory of the reference point G can be acquired. The controller 180 determines whether the reference trajectory GT corresponds to a predetermined specific gesture. For example, as shown in FIG. 9(a), a horizontal reference trajectory GT may be a gesture action corresponding to a function of adjusting a volume of the display device 100.

As shown in FIG. 9(b), the user can obliquely move the hand 132 to the downside after obliquely moving the hand 132 to the upside. When the user moves the hand 132, the reference point G also moves according to movement of the hand 132. When the reference trajectory GT is acquired by movement of the reference point G, the controller 180 executes a function corresponding thereto. For example, the reference trajectory GT shown in FIG. 9(b) may be a gesture action corresponding to a function of changing a channel of the display device 100.

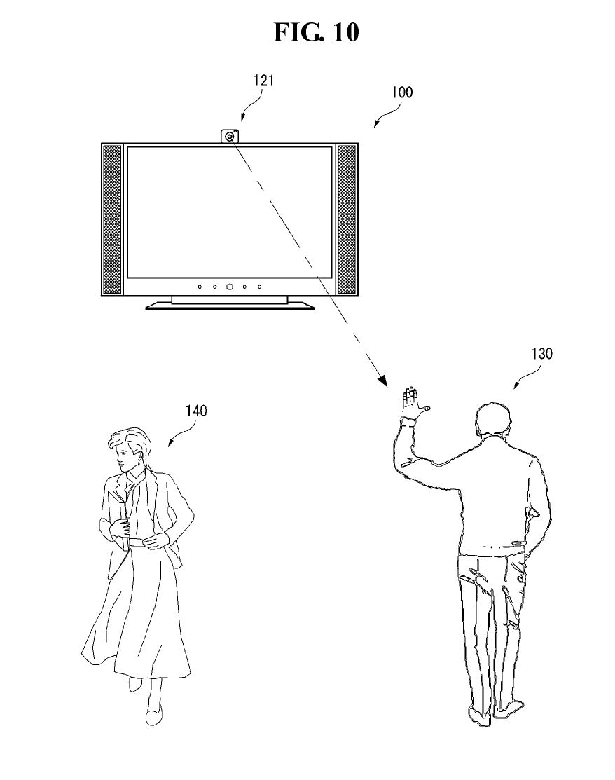

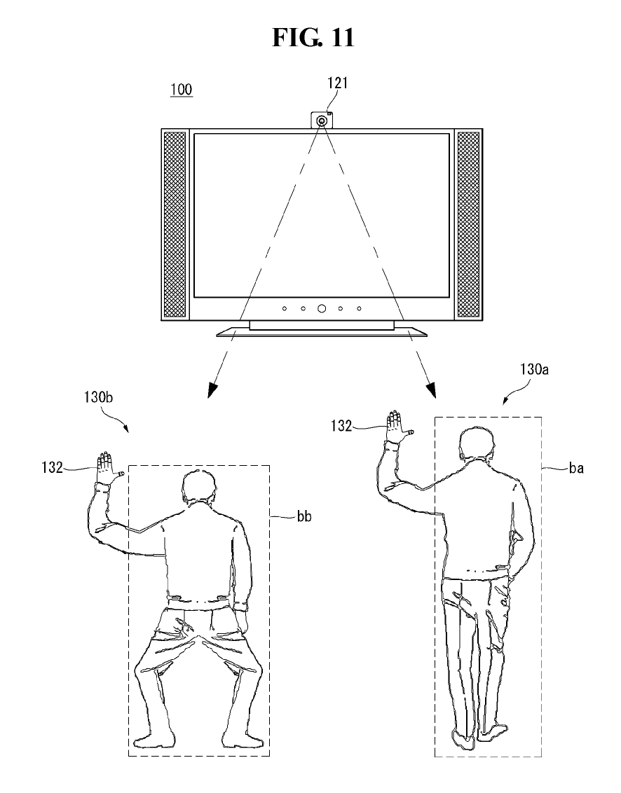

FIGS. 10 and 11 are diagrams illustrating a gesture action tracking process of the display device of FIG. 1.

Referring to FIGS. 10 and 11, the display device 100 according to an implementation of this document tracks the user 130 having a control right and receives a predetermined input from the user 130.

As shown in FIG. 10, an observer 140 other than the user 130 may exist at the front of the display device 100. The user 130 acquires a control right by performing a gesture action of acquiring a control right toward the camera 121. When the user 130 acquire the control right, until the user 130 loses the control right, the controller 180 tracks the user 130. That is, even when a plurality of persons are photographed, the controller 180 ignores a gesture action of the observer 140 and tracks only a gesture action of the user 130.

As shown in FIG. 11, the user 130 who acquires the control right can move other portions of a body other than the hand 132 that performs a control operation. For example, the user 130 who acquires the control right with a constant gesture using the hand 132 in an upright standing state, as in a first state 130a may perform an action of bending a knee, as in a second state 130b.

The controller 180 controls a control operation for performing various functions of the display device 100 to perform based on a gesture action by the set reference point G. That is, the controller 180 tracks only a gesture action by the hand 132 of the user 130 who acquires a control right and may ignore a gesture action by bodies ba and bb of the user. Therefore, a function of the display device 100 can be executed without having an influence on an action unconsciously taken by the user.

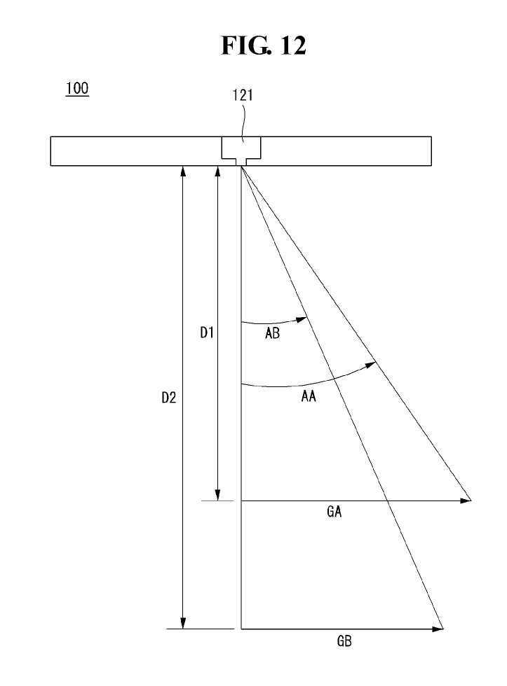

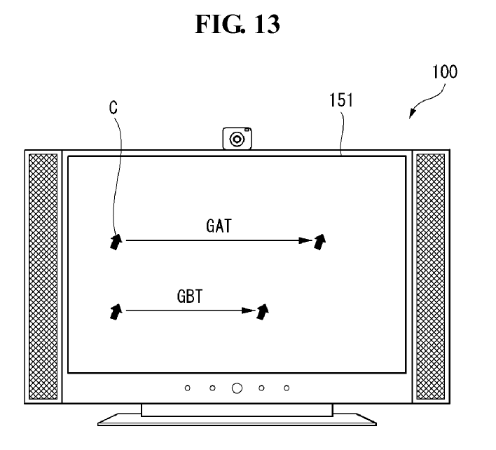

FIGS. 12 and 13 are diagrams illustrating a gesture action tracking process according to a distance of the display device of FIG. 1.

Referring to FIGS. 12 and 13, the display device 100 according to an implementation of this document performs an appropriate function according to a distance in which a user taking a gesture is separated from the camera 121.

As shown in FIG. 12, the user takes a gesture at a first distance D1 or a second distance D2 from the camera 121. As a distance from the camera 121 is different, even if lengths of gesture trajectories GA and GB taken by the user are equal, viewing angles AA and AB viewed by the camera 121 may be different. That is, even if the user takes the same gesture action, when the user is adjacently positioned to the camera 121, a viewing angle increases.

As shown in FIG. 13, when the user's a gesture action corresponds to a function of moving a cursor C, the controller 180 moves the cursor C to correspond to a first trajectory GA with respect to the first gesture trajectory GA and moves the cursor C to correspond to the second trajectory GB with respect to the second gesture trajectory GB. That is, the controller 180 controls to execute a specific function to correspond to a range of viewing angles AA and AB viewed by the camera 121 regardless of a size of a gesture action actually taken by the user. By controlling to execute a specific function to correspond to a range of viewing angles AA and AB viewed by the camera 180, the controller 180 may not perform a separate calculation for a correction according to a distance. Therefore, resources of the display device 100 can be more effectively used.

Although not specifically shown in FIG. 13, the controller 180 can move the cursor C in consideration of gesture trajectories GA and GB actually taken by the user regardless of a range of viewing angles AA and AB viewed by the camera 121. That is, lengths of the first and second gesture trajectories GA and GB can be equally set.

Although implementations have been described with reference to a number of illustrative implementations thereof, it should be understood that numerous other modifications and implementations can be devised by those skilled in the art that will fall within the spirit and scope of the principles of this disclosure. Therefore, various variations and modifications are possible in the component parts and/or arrangements of the subject combination arrangement within the scope of the disclosure, the drawings and the appended claims.

What is claimed is:

1. A display device comprising:
a camera configured to acquire an image comprising a gesture taken by a user; and
a controller configured to extract the gesture from the image acquired by the camera and set a specific point of an object to be a reference point when the extracted gesture comprises a gesture corresponding to acquisition of a control right.

2. The display device of claim 1, wherein the controller sets a specific point of an object in which the gesture is performed as the reference point when the gesture corresponding to acquisition of the control right has been sustained for a predetermined time period or more.

3. The display device of claim 2, wherein the controller sets a specific point of the hand as the reference point when a gesture using the user's hand toward the display device has been sustained for the predetermined time period or more.

4. The display device of claim 1, wherein the controller sets a central point of an object in which the gesture is performed as the reference point.

5. The display device of claim 4, wherein the object is a hand of a user of the display device.

6. The display device of claim 1, wherein the controller executes a function corresponding to a gesture of the reference point regardless of a gesture of the object other than the reference point when the reference point is set.

7. A display device comprising:
a camera configured to acquire an image of a user who acquires a control right; and
a controller configured to track a reference point comprised in the image and execute a function corresponding to a gesture trajectory formed by movement of the reference point after acquiring the control right.

8. The display device of claim 7, wherein the controller sets a specific point of an object in which the gesture is performed as the reference point when a specific gesture action has been sustained for a predetermined time period or more.

9. The display device of claim 8, wherein the controller sets a specific point of the hand as the reference point when a gesture using the user's hand toward the display device has been sustained for the predetermined time period or more.

10. The display device of claim 7, wherein the controller executes a function corresponding to the gesture trajectory regardless of the user's gesture other than the reference point.

11. A method of controlling a display device, the method comprising:
acquiring an image;
extracting a user's gesture from the acquired image; and
setting, when a gesture corresponding to acquisition of a control right is comprised in the extracted gesture, a specific point of an object in which the gesture is performed as a reference point.

12. The method of claim 11, wherein the setting of a specific point of an object comprises setting, when a gesture corresponding to acquisition of a control right has been sustained for a predetermined time period or more, the specific point as the reference point.

13. The method of claim 11, wherein the user's gesture is a gesture using the user's hand.

14. The method of claim 13, wherein the setting of a specific point of an object further comprises setting a central point of the hand as the reference point.

15. The method of claim 11, further comprising executing a function corresponding to a gesture of the reference point regardless of a gesture of the object other than the reference point.
